(19) United States
(12) Patent Application Publication
(10) Pub. No.: US 2025/0122713 A1
(43) Pub. Date: Apr. 17, 2025

(54) FLOOR DRAIN

(71) Applicant: DAVID BLAMBLE, Bellevue, NE (US)

(72) Inventor: DAVID BLAMBLE, Bellevue, NE (US)

(21) Appl. No.: 18/913,764

(22) Filed: Oct. 11, 2024

Related U.S. Application Data
(60) Provisional application No. 63/543,652, filed on Oct. 11, 2023.

(51) Int. Cl. E03F 5/04; F21S 4/20; F21V 33/00; F21Y 103/10

(52) U.S. Cl. CPC E03F 5/0408; F21S 4/20; F21V 33/006; F21Y 2103/10

(57) ABSTRACT

A floor drain system is provided comprising a coupler piece, extension pieces, end caps, and a drain cover. The drain coupler piece includes a connector for connection to a drain line and receivers for engagement with drain extension pieces, forming a drain main body. The main body includes opposed side walls and a floor forming a channel for liquid to flow and drain. Each side wall includes a lip extending inward and along the length of the drain and configured for mounting a grate. End caps are configured for sealing ends of the drain. Alternatively, a light box end piece can be utilized to seal an end of the drain while providing a housing and access point for drain lighting. Tile can be installed overlaying at least part of a top surface of each side wall or abutting the drain. The drain extension pieces can be cut to size.

### CROSS-REFERENCE TO RELATED APPLICATIONS

This application claims priority pursuant to 35 U.S.C. § 119(e) to co-pending U.S. Provisional Patent Application Ser. No. 63/543,652, filed Oct. 11, 2023, the entire disclosure of which is incorporated herein by reference.

### FIELD OF THE INVENTION

The present invention relates generally to plumbing drains. More specifically, the present invention relates to a drain particularly well suited for use in tiled showers, basins, or the like.

### BACKGROUND OF THE INVENTION

Tile basins for showers and the like are extremely popular in interior design today. Typically, a tile basin is constructed by first placing a cement backer board over a subfloor at the desired location. Next a bottom waterproofing layer is applied to the cement board. Concrete is then poured over the bottom waterproofing layer, and a top waterproofing layer is applied to the concrete after it has hardened. Finally, the tile is applied above the top waterproofing layer. The cement board, the bottom waterproofing layer, and the concrete are all installed around the housing of a drain for the basin.

Typically a gap of approximately 1 ½ inches is left between the drain housing and the edge of the second waterproofing layer. This is intended to allow moisture to seep through the concrete and into the drain through weep holes in the drain housing. Notwithstanding, in reality, such weep holes around the sides of the drain housing do very little to ensure that all moisture captured within the basin actually exits through the drain. Moreover, intentionally allowing moisture to seep into the concrete can often result in leaks and other problems. Therefore, it would be beneficial to provide a tile floor drain that is completely “watertight” (e.g., allows for the top waterproofing layer to continue all the way to the edge of the drain body).

Furthermore, some consumers find standard tile basin circular drains to be bland or even unsightly. Particularly for higher end homes, sleek, modern-looking designs are desirable to many consumers. Accordingly, it would be beneficial to have a tile drain which is modern, sleek, and attractive to consumers.

With modern interior design in mind, linear drains are often desirable for larger tile basins. Such linear drains are typically designed to extend from wall to wall within the basin. As such, linear drains are typically custom-ordered and manufactured to the specific length required for a particular basin, often requiring four to six weeks of lead time. This results in linear drains being extremely time consuming to install (often requiring the four- to six-week wait until a custom drain is manufactured), as well as being very expensive. Accordingly, it would be beneficial to have a linear drain which is quick and easy to install and reasonably priced.

Some adjustable length linear drains have been developed, but such drains require the installer to piece together multiple “links” until the desired length of drain is obtained. This is extremely time consuming and cumbersome for the installer. In addition, the complexity and multiple components of such drains create ample opportunity for improper installation and leakage. Therefore, it would be beneficial to provide a linear tile floor drain that is capable of easier installation in basins of varying dimensions. Furthermore, it would be beneficial to have a tile drain which is sleek and attractive while still being watertight.

Installing lighting within shower basins is also often a challenge. Moreover, replacing and/or repairing lighting features within a shower basin can be extremely difficult. Accordingly, it would be beneficial to have a tile drain which accommodates easy installation of and access to lighting within or attached to the tile drain.

Heretofore there has not been available a floor drain system or method with the advantages and features of the present invention.

### SUMMARY OF THE INVENTION

The present invention comprises a floor drain system and method. In an exemplary embodiment, the floor drain system of the present invention is configured for installation within a tile basin. In an exemplary embodiment, at least a portion of the tile drain system is configured to be installed beneath a tile floor such that a portion of the tile floor overlays a portion of the drain system. In an exemplary embodiment, a base of the floor drain system is configured to engage with the floor of a tile basin. In an exemplary embodiment, the drain of the present invention is generally linear in shape.

In an exemplary embodiment, the floor drain system includes a drain coupler piece including a drain connector defining a coupler opening therethrough. In an exemplary embodiment, the drain connector is configured to be positioned downward and to engage with a wastewater drain line, such as a connection line to a sewer system, septic tank, or alternative drainage system.

In exemplary embodiment, the drain coupler piece further includes a raised portion adjacent to a top portion of the coupler opening. In an exemplary embodiment, two sides of the coupler piece further comprise side walls. In an exemplary embodiment, two sides of the coupler piece are each configured to receive and engage with a drain extension piece. In an exemplary embodiment, when drain extension piece(s) are connected to the drain coupler piece, the top of the floor and side walls of the extension piece(s) are aligned or flush with the raised portion of the coupler piece. In embodiments, the coupler piece and drain extension pieces are configured for sealable connection to each other. In an exemplary embodiment, the combination of a drain coupler piece and a drain extension piece on each side of the coupler piece forms a “main body” of the drain.

In an exemplary embodiment of the present invention, a drain system kit of the present invention comes with one or more drain extension pieces configured to be cut to a desired size for attachment on either side of the coupler piece.

In an exemplary embodiment, the drain main body forms a channel for liquid, such as but not limited to wastewater, to flow and to drain out through the coupler opening and down the wastewater drain line. In an exemplary embodiment, such channel is formed between the drain main body side walls. In an exemplary embodiment, the drain main body further defines a generally rectangular top opening that is positioned at an upper end of the channel.

In an exemplary embodiment, the side walls of the drain main body each include a lip which extends longitudinally along the length of the drain and inward a distance toward the drain. In an exemplary embodiment, the side wall lips of the coupler piece are configured to align and connect to the side wall lips of the drain extension pieces such that the drain main body includes continuous side wall lips. In an exemplary embodiment, the side wall lips are configured to receive and mount a drain cover or grate.

In an exemplary embodiment, the floor drain system further comprises end caps for attachment to the ends of the drain. In an exemplary embodiment, each end cap includes tabs configured for engaging with a drain extension piece and for providing a seal for the end of the drain.

In a further exemplary embodiment of the present invention, a light box assembly comprising a light box end piece is utilized in place of one or both end caps. The light box end piece of the present invention is configured to seal off an end of the drain main body while also providing access for placing waterproof lighting within the drain channel and/or along the bottom of the drain cover or grate, such as but not limited to submersible LED light strips. In an exemplary embodiment, the light box end piece selectively couples to the end of a drain extension piece and defines a hollow housing having a bottom opening in line with the drain main body channel. The light box end piece housing extends a distance outward from the drain main body longitudinally in line with the drain main body and further extends a distance upward at approximately a right angle from the bottom wall of the main drain body. In an embodiment, the light box further defines a housing upper opening at a top side of the housing, the upper opening positioned approximately perpendicular to the housing bottom opening.

In exemplary embodiments, the light box end piece is configured for being positioned in line with or behind a sheet of drywall. In some embodiments, the light box end piece further comprises an access door adjacent to the drain main body for access to components housed within the light box. In embodiments, a tile wall can be placed over an inner side of the light box end piece housing. In other embodiments, tiles of a tile wall are placed around a light box access door and/or a tile access door or panel is installed in association with the tile wall to allow access to the light box.

In an exemplary embodiment of the present invention, the light box assembly allows an installer to insert lighting, such as but not limited to a light strip, into the internal space of the drain main body channel. In an exemplary embodiment, lighting can be extended through the light box housing bottom opening and into the housing. The lighting can further be connected to a power source, as needed, out through the light box housing upper opening. The present light box assembly allows an installer to add lighting to the drain system while still maintaining a sleek design to the drain. Furthermore, in embodiments, the light box assembly housing openings allow a user to easily access the lighting, as needed.

In some embodiments, the floor drain system further comprises magnets for magnetically interacting with magnets on a drain grate or with a metal drain grate itself.

In an exemplary embodiment of the present invention, a floor drain system grate is configured for placement over and to rest on the side wall lips which extend along the longitudinal length of the drain. In an exemplary embodiment, the drain cover or grate is configured for positioning approximately in line with the tile floor of a tile basin adjacent to the drain.

In an exemplary embodiment, the present drain system further comprises shims to allow the height of the drain cover or grate to be adjusted up and down. The number and/or thickness of shims depends upon the thickness of the tile and is chosen by the installer to place the height of the drain cover or grate such that it is flush with the top of the adjacent tile or otherwise at a desired height.

In an embodiment, a tile floor can be installed overlaying all or a portion of a top surface of one or both drain main body side walls. In further embodiments, a tile floor can be installed abutting the drain system of the present invention. Once installed, the present drain system is configured to direct liquid from the tile basin in which it is installed to a corresponding wastewater drain line.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 shows an upper, exploded, plan view of a drain system embodying the present invention.

FIG. 2 shows a lower, exploded, perspective view of a coupler piece and two drain extension pieces of the drain system, which pieces make up the drain main body when assembled.

FIG. 3 shows an upper, perspective view of the drain main body, with the drain coupler piece and drain extension pieces detached.

FIG. 4 shows an upper, plan view of the drain main body, with the drain coupler piece and two drain extension pieces assembled together.

FIG. 5 shows an upper, perspective view of a drain coupler piece of the present drain system.

FIG. 6 shows a lower, perspective view of the drain coupler piece.

FIG. 7 shows a side, elevational view of the drain coupler piece.

FIG. 8 shows a top, plan view of the drain coupler piece.

FIG. 9 shows a cross-sectional, elevational view of the drain coupler piece.

FIG. 10 shows an end, elevational view of the drain coupler piece.

FIG. 11 shows a lower, perspective view of a drain extension piece of the present drain system.

FIG. 12 shows a top, plan view of the drain extension piece.

FIG. 13 shows a cross-sectional, elevational view of the drain extension piece.

FIG. 14 shows a side, elevational view of the drain extension piece.

FIG. 15 shows a perspective view of an end cap of the present drain system.

FIG. 16 shows a top, plan view of the end cap.

FIGS. 17-18 show end, elevational views of the end cap.

FIGS. 19-20 show side, elevational views of the end cap.

FIG. 21 shows a lower, perspective view of a light box end cap piece of the present drain system.

FIG. 22 shows a proximal end, elevational view of the light box end cap piece.

FIG. 23 shows a top, plan view of the light box end cap piece.

FIG. 24 shows a cross-sectional, plan view of the light box end cap piece.

FIG. 25 shows a side, elevational view of the light box end cap piece.

FIG. 26 shows a cross-sectional, elevational view of the light box end cap piece.

FIGS. 27-29 show upper perspective views of a portion of a drain system of the present invention utilizing a light box end cap piece and waterproof lighting within the drain channel.

FIG. 30 shows a side, elevational view of a shim of the present drain system.

FIG. 31 shows an end, elevational view of the shim.

FIG. 32 shows a cross-sectional, elevational view of a drain system of the present invention installed within a tile basin.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a floor drain system and method. In an exemplary embodiment, the floor drain system 1 of the present invention is configured for installation within a tile basin. In alternative embodiments, the drain system 1 of the present invention can be installed within or in association with any other type of floor needing a drain.

In an exemplary embodiment, at least a portion of the tile drain system 1 of the present invention is configured to be installed beneath a tile floor such that a portion of the tile floor overlays a portion of the drain system 1. In an exemplary embodiment, a base of the floor drain system 1 is configured to engage with the floor of a tile basin. In an exemplary embodiment, the drain 1 of the present invention is generally linear in shape.

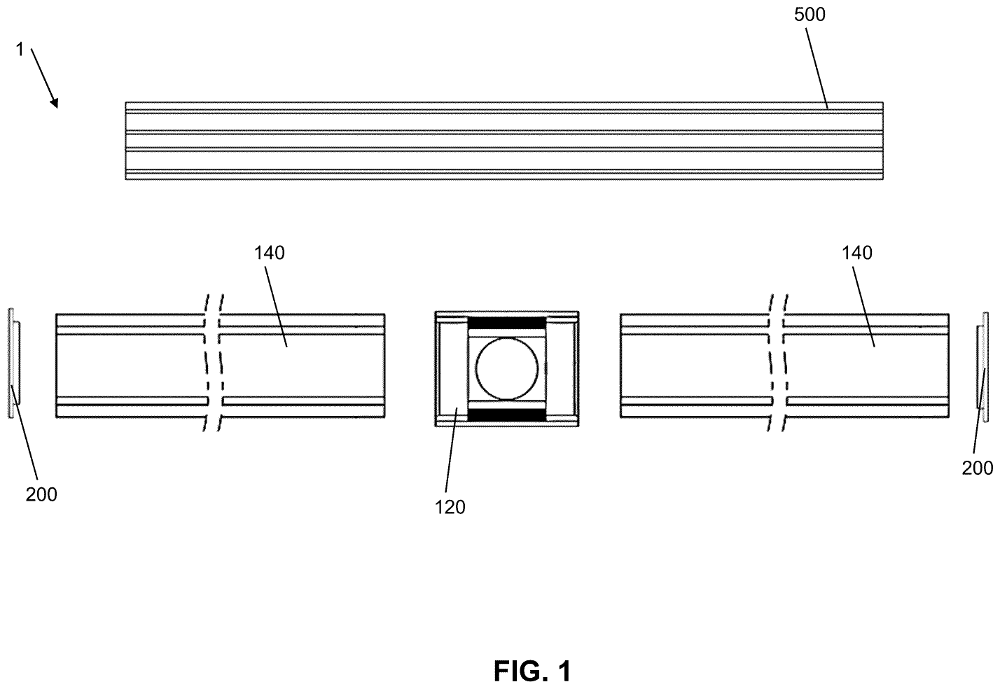

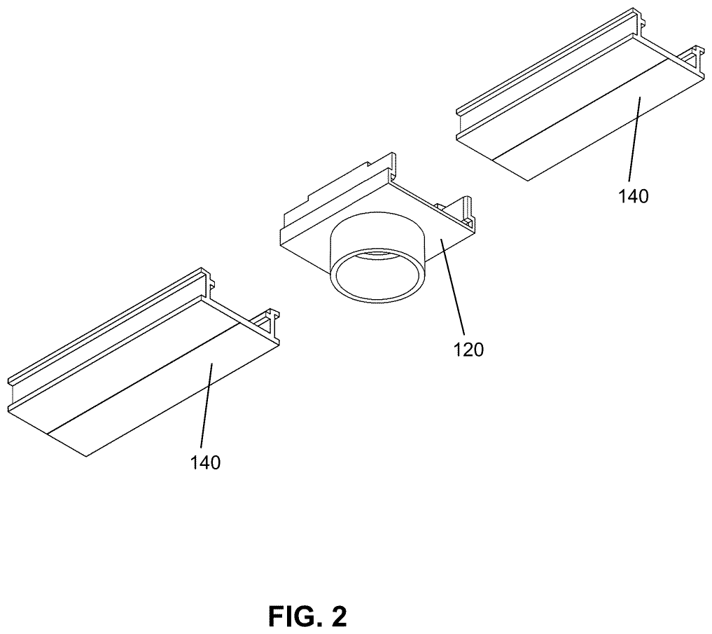

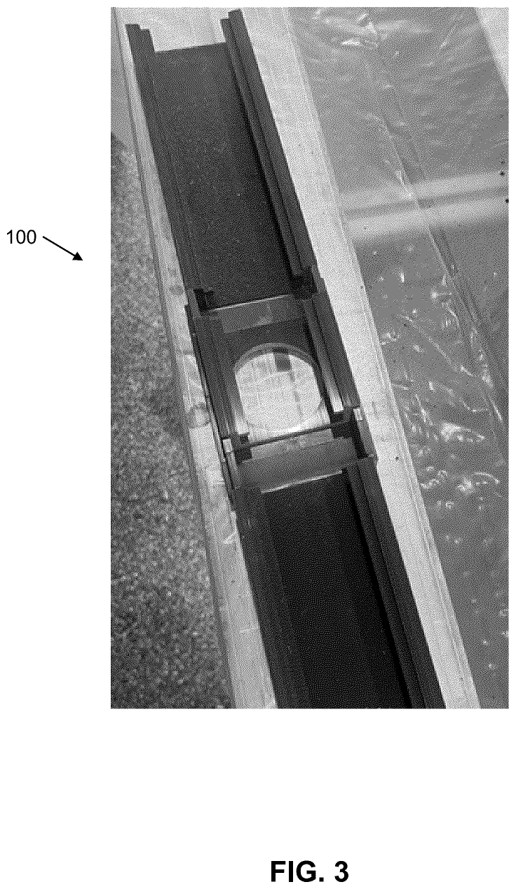

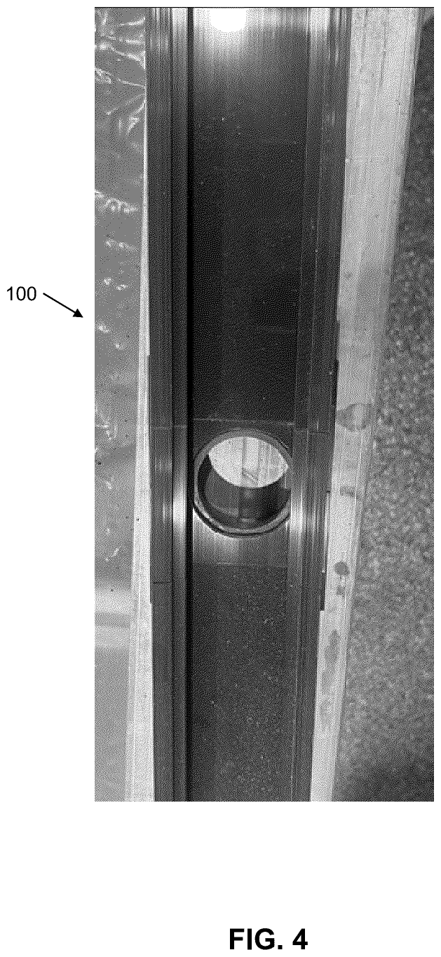

In an exemplary embodiment of the present invention, the drain system 1 comprises a drain main body 100 made up of a coupler piece 120 and two drain extension pieces 140. In an exemplary embodiment, the coupler piece 120 is configured to engage with a drain extension piece 140 on opposing sides of the coupler piece 120. In an exemplary embodiment, the drain system 1 further comprises end caps 200, each end cap 200 configured to engage with a distal end of a drain extension piece 140. Furthermore, in an exemplary embodiment, the drain system 1 includes a drain cover or grate 500. FIGS. 1-3 show disassembled views and FIG. 4 shows an assembled view of components of an exemplary embodiment of the drain system 1.

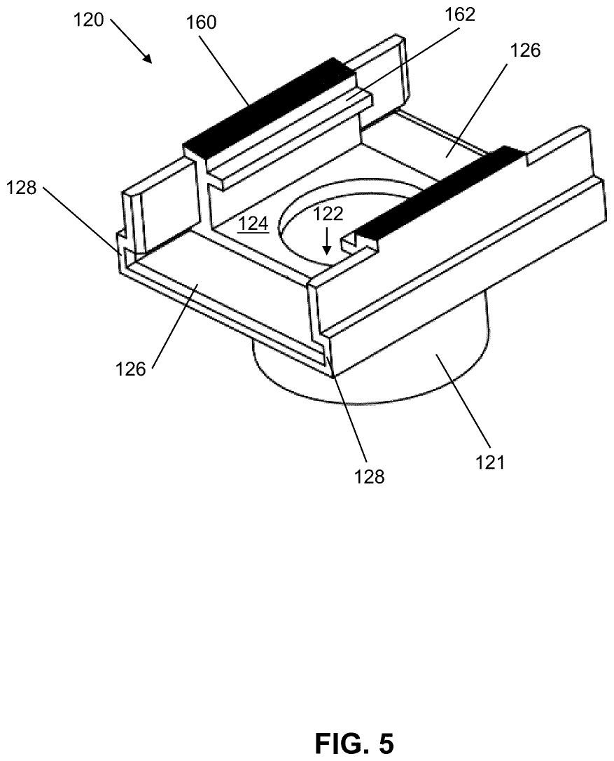

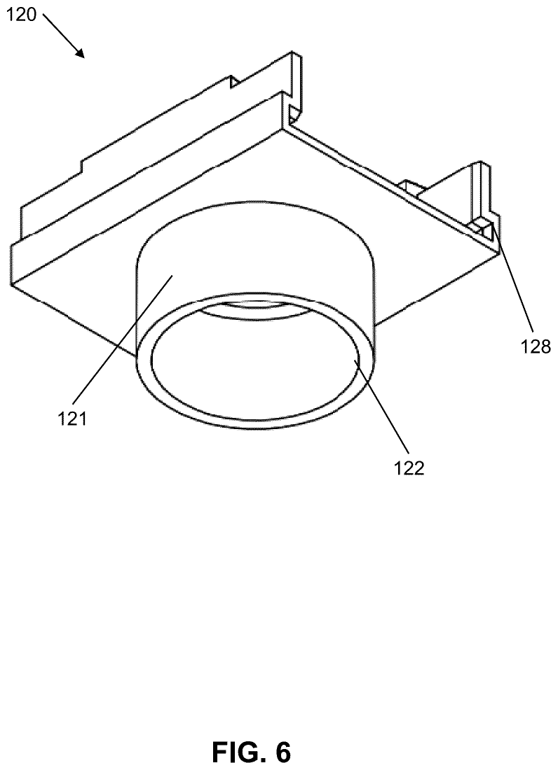

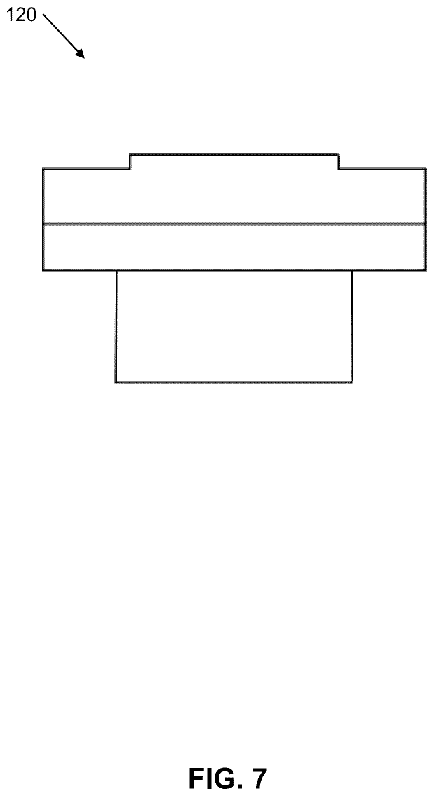

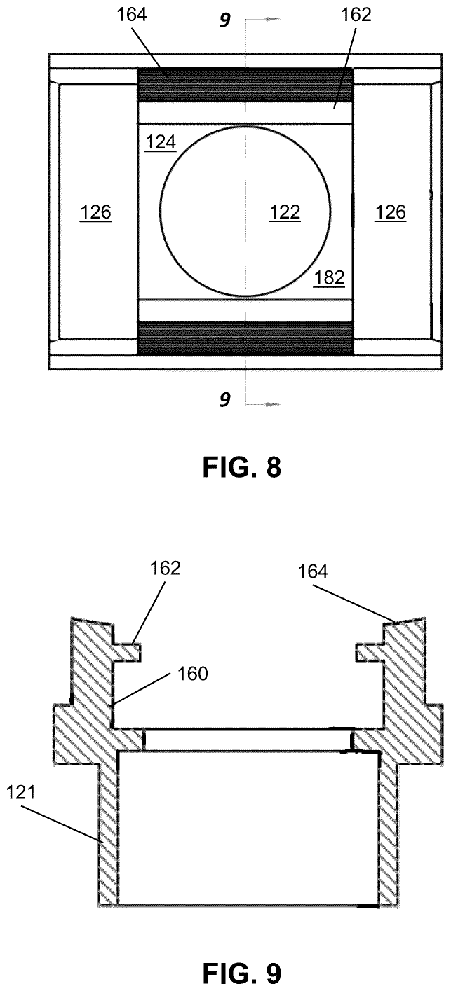

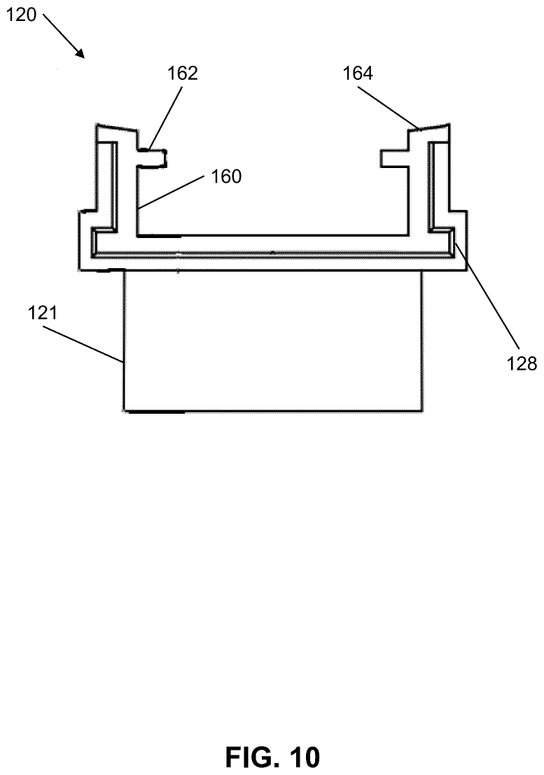

FIGS. 5-10 show an embodiment of a coupler piece 120 of the present drain system 1. In an exemplary embodiment, the drain coupler piece 120 comprises a drain connector 121 which defines a coupler opening 122. In an exemplary embodiment, the drain connector 121 is configured to be positioned downward and to engage with a wastewater drain line, such as but not limited to a connection line to the sewer system, septic tank, or alternative drainage system. In an exemplary embodiment, the drain coupler piece 120 is positioned generally in a central location along the longitudinal length of the floor drain system 1. In alternative embodiments, the drain coupler piece 120 is positioned at any point along the longitudinal length of the drain system 1, as is preferable for drainage and connection to the wastewater drain line.

In an exemplary embodiment, the drain coupler piece 120 includes a substantially square-shaped or rectangular, raised portion 124 adjacent to a top portion of the coupler opening 122, with two sides of the raised portion parallel to the longitudinal length of the drain and two sides of perpendicular to the longitudinal length of the drain. In an exemplary embodiment, the two sides parallel to the longitudinal length of the drain further include side walls of the drain coupler piece 120. In an exemplary embodiment, the coupler piece raised portion 124 forms a coupler portion of a floor 182 and side walls 160 of the drain main body 100.

In an exemplary embodiment, the coupler piece 120 further comprises first and second receivers 126 on opposing sides in the direction of the longitudinal length of the drain. Each receiver 126 is configured to receive, engage with, and connect to a drain extension piece 140 of the drain system 1. In an exemplary embodiment, each receiver 126 includes an extension outward from the coupler portion of each side wall 160 a length along the longitudinal length of the drain which are connected to a recessed extension outward from the coupler portion of the drain floor 182. The connections between the side wall extensions and the floor extension of each receiver, at the base of the side wall extensions and the outer edges of the floor extension, each include a “C-shaped” section 128 configured to receive and closely fit around a lower brim 142 of each drain extension piece 142.

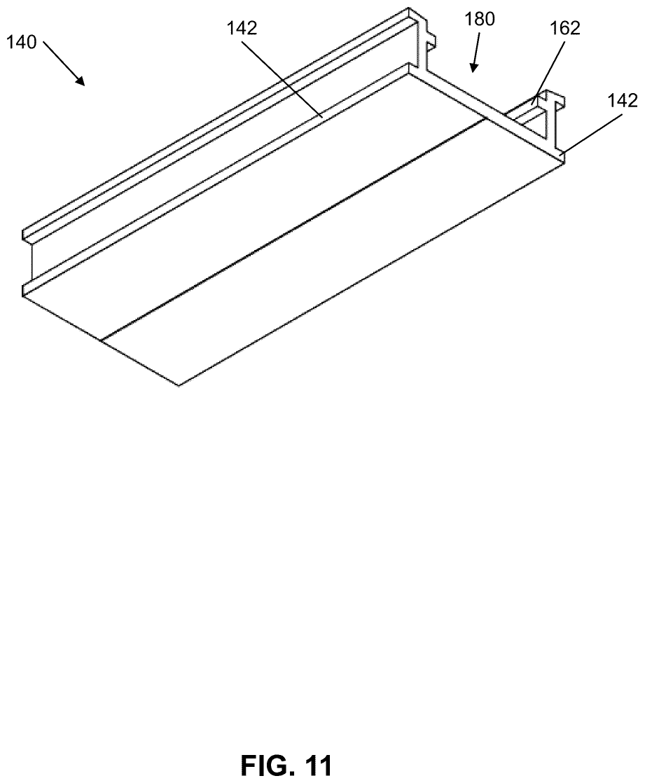

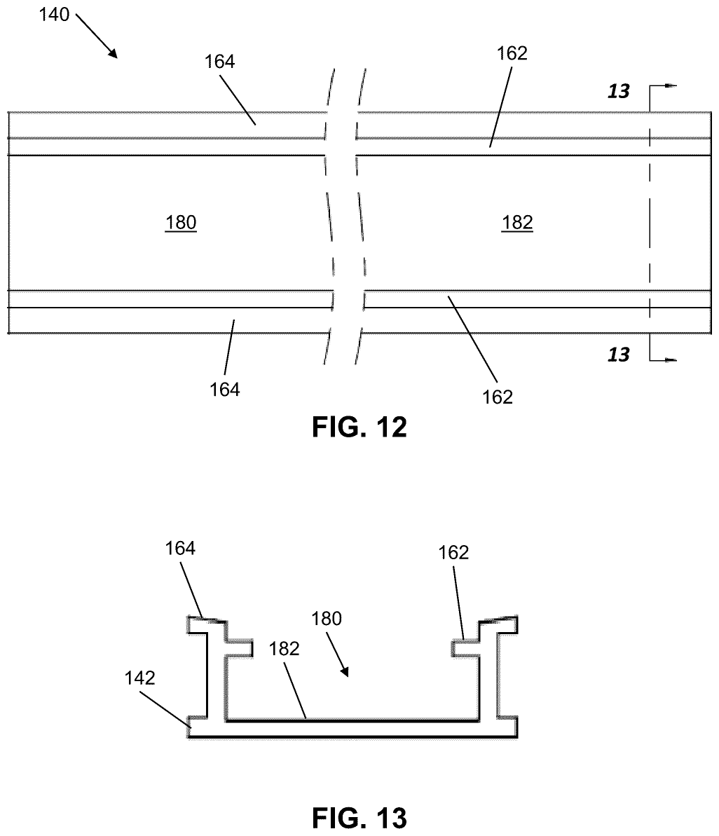

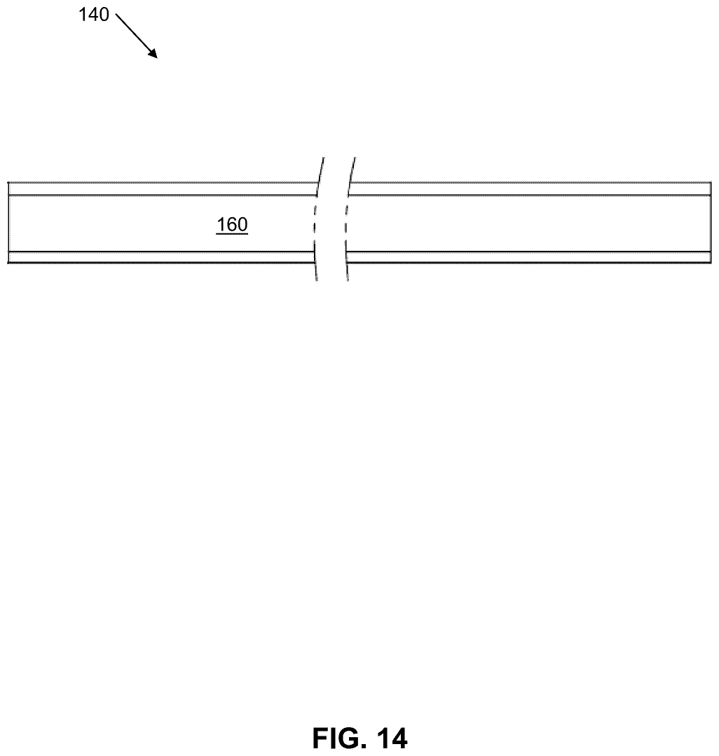

FIGS. 11-14 show additional views of an embodiment of a drain extension piece 140 of the present invention.

In an exemplary embodiment of the present invention, when drain extension piece(s) 140 are connected to the drain coupler piece 120, the top of the floor 182 and side walls 160 of the extension piece(s) 140 are aligned or flush with the raised portion 124 of the coupler piece 120. In embodiments, the coupler piece 120 and drain extension pieces 140 are sealingly connected with a watertight sealant or adhesive, such as but not limited to a PVC adhesive, a silicone adhesive, or some other bonding agent now known or later developed. In further embodiments, the coupler piece 120 and drain extension pieces 140 are configured to connect to each other via sealing compression fitting connections, snapping mechanism, and/or any other mechanical means for watertight connection now known or later developed. In an exemplary embodiment, the combination of a drain coupler piece 120 and a drain extension piece 140 on each side of the coupler piece 120 form the “main body” 100 of the drain.

In an exemplary embodiment of the present invention, a drain system kit of the present invention comes with one long drain extension piece 140, which piece is configured to be cut to a desired size and into two pieces for attachment on either side of the coupler piece 120, respectively. In some embodiments, a user cuts the long drain extension piece 140 into two pieces equal in length. In other embodiments, the drain extension piece 140 is cut into segments which are not equal in size. In further alternative embodiments, a drain system kit of the present invention includes multiple drain extension pieces 140, each of which can be cut to size as desired and/or pieced together and connected with multiple extension pieces 140 in series.

In an exemplary embodiment, the drain main body 100 forms a channel 180 for liquid, such as but not limited to wastewater, to flow and to drain through the coupler opening 122 and down the wastewater drain line. In an exemplary embodiment, such channel 180 is formed by the floor 182 connection between the drain main body side walls 160. The side walls 160 form opposed first and second inner walls positioned between first and second outer walls and opposed first and second top surfaces 164 extending between the respective inner and outer walls, and the drain further includes a floor 182, or bottom wall, extending between the side walls 160. In this way, the drain main body 100 defines an elongated interior area, or channel 180, that is positioned between the first and second inner walls and defines a rectangular top opening that is positioned at an upper end of the channel 180. In embodiments, the floor 182, or bottom wall, defines the coupler piece bottom opening 122.

In an exemplary embodiment, the side walls 160 of the drain main body 100 each include a lip 162 extending longitudinally along the length of the drain and inward a distance toward the drain. In an exemplary embodiment, the side wall lips 162 of the coupler piece 120 are configured to align and connect to the side wall lips 162 of the drain extension pieces 140 such that the drain main body includes continuous side wall lips 162. In an exemplary embodiment, the side wall lips 162 are configured to receive and mount a drain cover or grate 500.

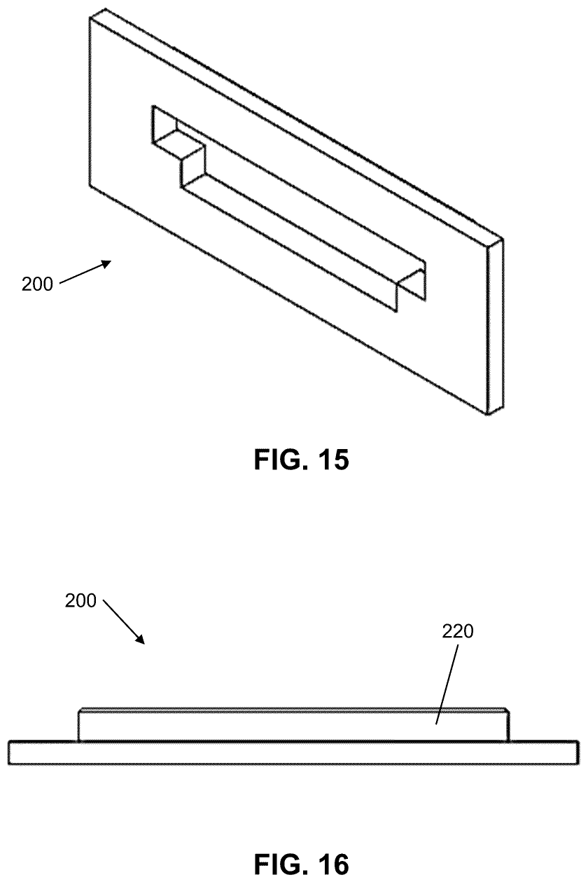

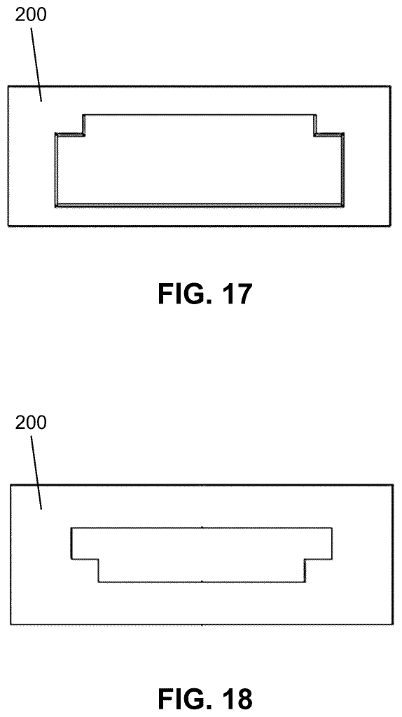

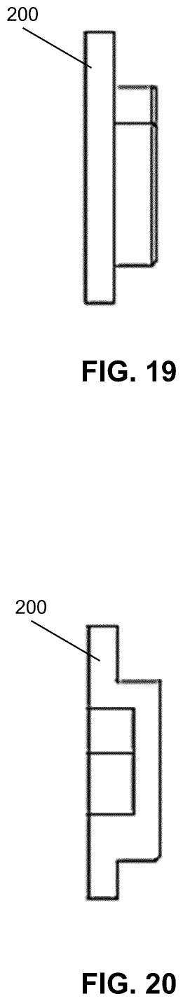

In an exemplary embodiment, the floor drain system 1 further comprises end caps 200 for attachment to the ends of the drain, an exemplary embodiment of which is shown in FIGS. 15-20. In an exemplary embodiment, each end cap 200 includes tabs 220 configured for engaging with a drain extension piece 140 and for providing a seal for a distal end of the drain. In some such embodiments, the end cap 200 is configured to selectively couple to the end of the drain main body 100, such as via sealing compression fitting connections, snapping mechanism, and/or any other mechanical means for watertight connection now known or later developed. In other such embodiments, the end cap 200 is bonded to the end of the drain main body 100 via watertight sealant or adhesive, such as but not limited to a PVC adhesive, a silicone adhesive, or some other bonding agent now known or later developed. In embodiments, each end cap 200 is sealed to the drain main body 100 so as to prevent fluid from escaping the drain main body 100.

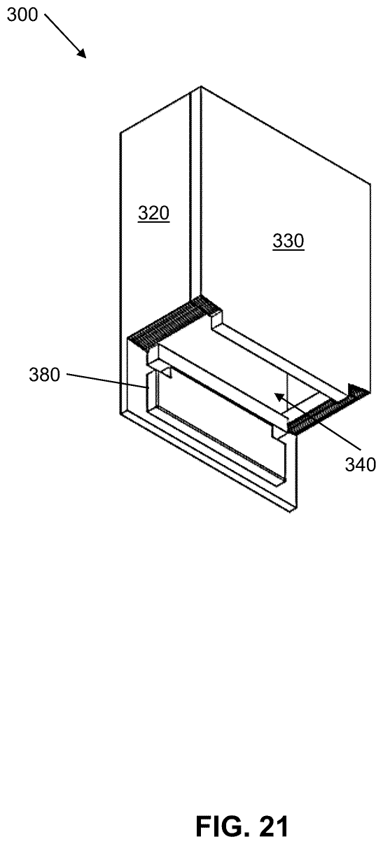

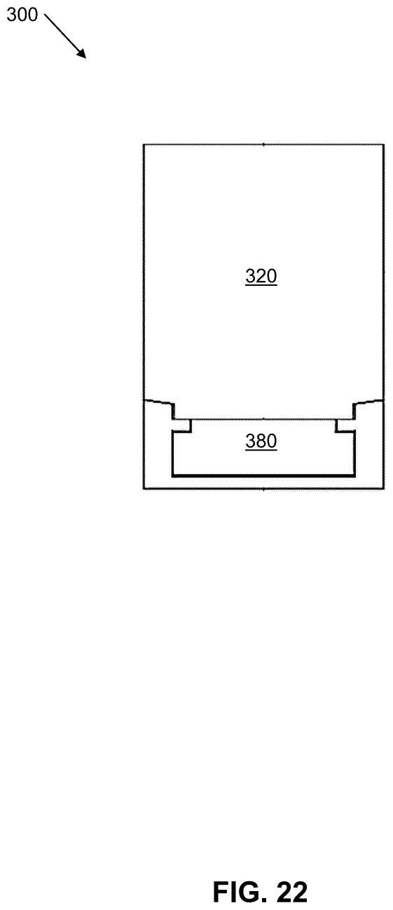

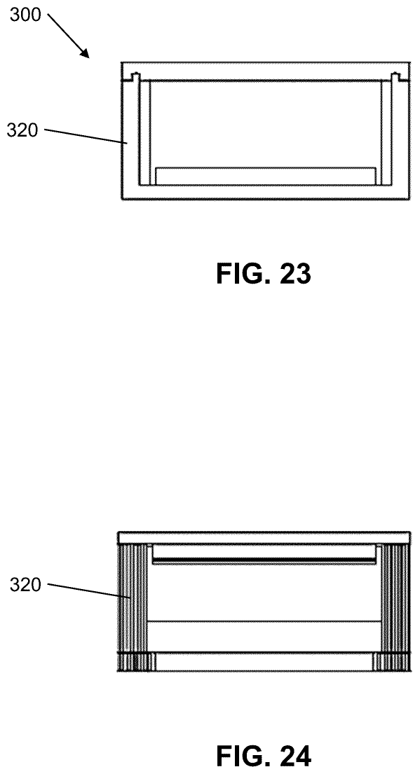

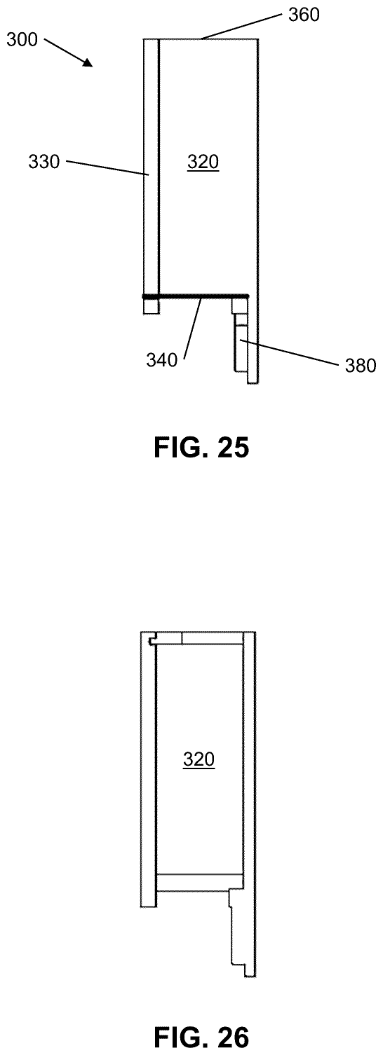

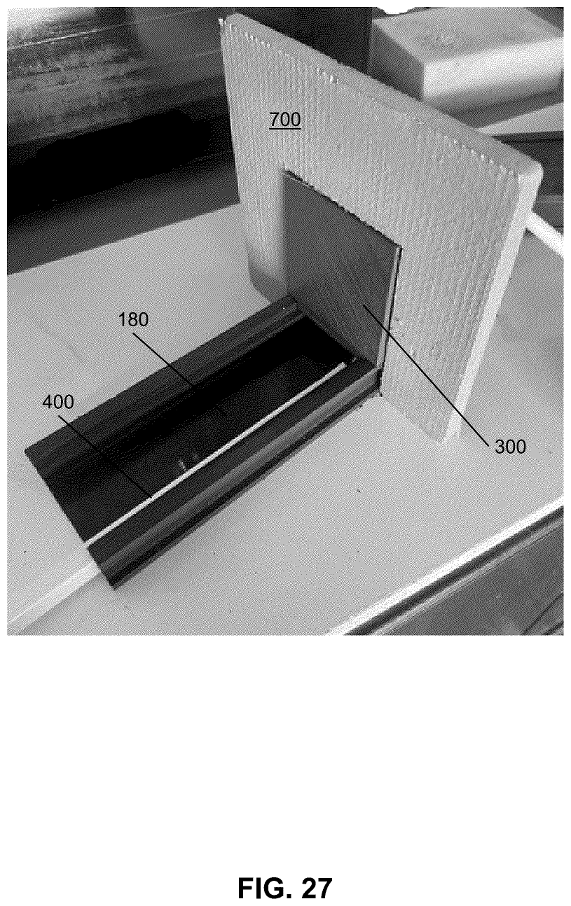

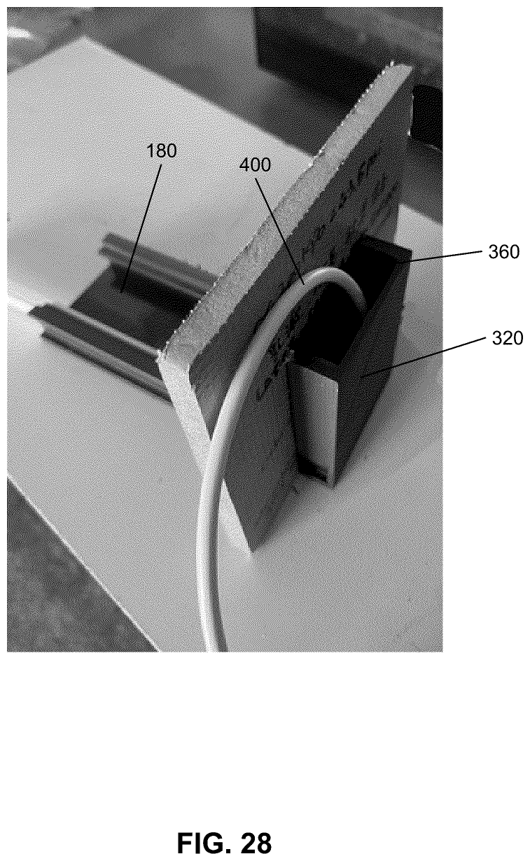

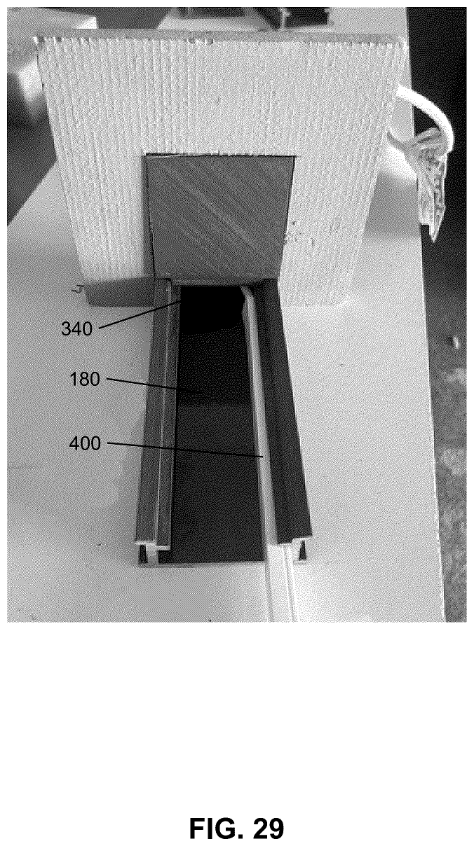

In a further exemplary embodiment of the present invention, a light box assembly comprising a light box end piece 300 is utilized instead of one or both end caps 200. An exemplary embodiment of a light box assembly of the present invention is shown in FIGS. 21-29. The light box end piece 300 of the present invention is configured to seal off an end of the drain main body 100, similar to the standard end cap piece, while also providing access for placing waterproof lighting 400 within the drain channel 180 and/or along the bottom of a drain cover or grate 500, such as but not limited to submersible LED light strips.

In an exemplary embodiment, the light box end piece 300 selectively couples to a distal end of a drain extension piece 140 with a sealing connector 380 in the same manner as the standard end cap 200 discussed above. In an exemplary embodiment, the light box end piece 300 further defines a hollow housing 320 having a bottom opening 340 into the drain main body channel 180 when assembled. The light box end piece housing 320 extends a distance upward at approximately a right angle from the floor 182 of the main drain body 100. In an exemplary embodiment, the light box housing 320 extends upward a distance at least twice the height of the drain main body 100. In other embodiments, the light box end piece 320 extends upward a distance more than triple, quadruple, quintuple, sextuple, septuple, or octuple the height of the drain main body 100, approximately the same height as the drain main body 100, approximately twice the height of the drain main body 100, approximately triple the height of the drain main body 100, approximately quadruple the height of the drain main body 100, or any other height as desired. In an embodiment, the light box end piece 300 further defines a housing upper opening 360 at a top side of the housing 320 opposite the housing bottom opening 340.

In exemplary embodiments, a proximal side of the light box end piece 300 is configured for being positioned in line with or behind a sheet of drywall 700. In an embodiment, an installer cuts a piece of drywall 700 around the light box housing 320 such that the proximal side of the housing 320 is positioned in line with the drywall 700. In some embodiments, the light box end piece 300 further comprises an access door 330 adjacent to the drain main body 100 for access to components housed within the light box housing 320. In other embodiments, a tile wall can be placed over a proximal side, or inner side, of the light box end piece housing 320. In other embodiments, tiles of a tile wall are placed around a light box housing 320 and/or a tile access door or panel is installed in association with the tile wall to allow for access to the light box housing 320.

In an exemplary embodiment of the present invention, the light box assembly allows an installer to insert lighting 400, such as but not limited to a light strip, into the internal space of the drain main body channel 180. In an exemplary embodiment, lighting 400 can be extended into the main body channel 180 through the light box housing bottom opening 340, with some of the lighting components housed within the light box housing 320. The lighting 400 can further be connected to a power source, as needed, out through the light box housing upper opening 360. The present light box assembly allows an installer to add lighting 400 to the drain system 1 while still maintaining a sleek design to the drain. Furthermore, the light box housing openings allow a user to easily access the lighting 400 behind an adjacent wall, as needed.

In some embodiments, the floor drain system 1 further comprises magnets for magnetically interacting with magnets on a drain grate 500 or with a magnetic metal drain grate 500 itself. In some embodiments, the floor drain system 1 further comprises magnet holders configured for mounting magnets along the longitudinal length of the drain. Such magnet holders each include a magnet housing and a tab configured for attachment to the coupler piece and/or drain extension piece(s). In some embodiments, magnets are held within a drain magnet housing via a compression fitting. In other embodiments, magnets are attached within a drain magnet housing with an adhesive or via any other attachment mechanism. In an embodiment, magnet holder pieces are attached to the coupler piece and/or extension drain piece(s) with an adhesive. In embodiments, magnet holder pieces are attached to the other pieces of the drain system with a PVC adhesive, a silicone adhesive, or any other bonding agent. In further embodiments, the magnet holder pieces are attached to the other pieces of the drain system with fasteners or via any other attachment mechanism. In an embodiment, magnet holder pieces are spaced along the longitudinal length of the drain system. In embodiments, one, two, three, four, five, six, seven, eight, nine, 10, 11, 12, or any other number of magnet holders are positioned along the length of the drain system. In other embodiments, magnets are integrated into the coupler piece and/or drain extension piece(s) without use of magnet holder pieces.

In an exemplary embodiment of the present invention, a floor drain system cover or grate 500 is configured for positioning over and resting on the side wall lips 162 which extend along the longitudinal length of the drain. In an exemplary embodiment, the drain cover or grate 500 is configured for positioning approximately in line with the tile floor of a tile basin adjacent to the drain. In an embodiment, the grate 500 is made up of metal and includes a series of magnets or is magnetic and configured for magnetic interaction with magnets positioned along the longitudinal length of the drain. In other embodiments, the drain main body 100 and drain cover or grate 500 do not utilize magnetic interaction connections. In other embodiments, the drain cover or grate 500 is made of any suitable material other than metal. In embodiments, the drain cover or grate 500 can include any design or style capable of allowing water or other liquid to flow through.

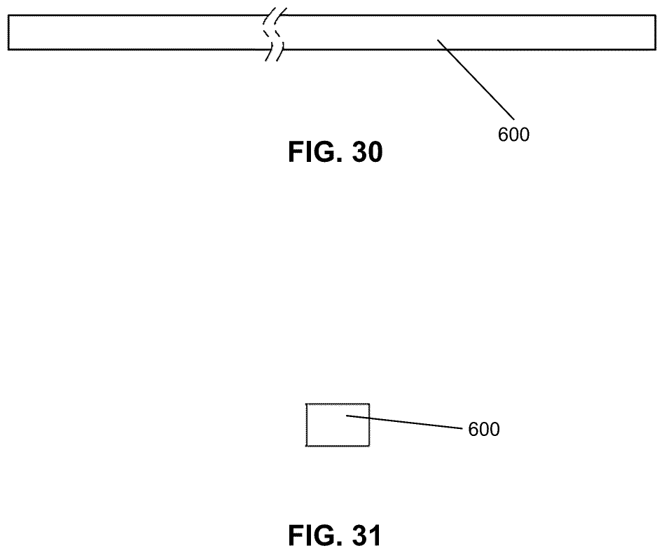

In an exemplary embodiment, the present drain system 1 further comprises shims 600 to allow the height of the drain cover or grate 500 to be adjusted up and down. FIGS. 30-32 show an embodiment of shims 600 of the present invention. In some embodiments, shims 600 are glued or otherwise connected to the lip 162 that extends along each side wall 160 of the drain main body 100 for supporting the drain cover or grate 500. The number or thickness of shims 600 utilized depends upon the thickness of the surrounding tile. In an embodiment, an installer utilizes shims 600 as desired to adjust the height of the drain cover or grate 500 such that it is flush or near flush with the top of adjacent tile.

In some embodiments in which the linear drain is intended to be installed generally centrally within a basin, the drain main body is generally symmetrical about a longitudinal axis of the drain. In such embodiments, tile 800 can be installed over the top surface 164 of the drain main body 100 up to both sides of the main drain channel opening. In exemplary embodiments, the drain system 1 of the present invention is configured for installation adjacent to one or more waterproofing layers of a tile basin, such as but not limited to waterproofing foam layer(s) 900 and other types of waterproofing layers. Tiles 800 of a tile floor can be installed over such waterproofing layer(s) and over, partially over, or adjacent to a top surface of the drain.

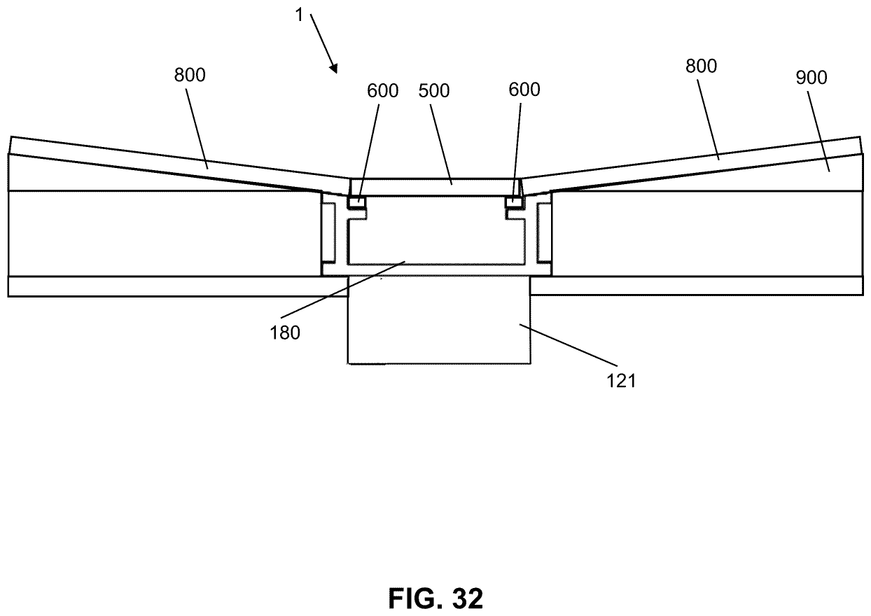

FIG. 32 shows an exemplary embodiment of a drain system 1 of the present invention installed within a tile basin with tile 800 overlaying the top surface 164 of each main body side wall 160. The embodiment shown in FIG. 32 further illustrates the use of shims 600 to bring the drain cover or grate 500 in line with adjacent tile 800.

In other embodiments, in which the linear drain system is intended to be installed along a side wall of the basin, the drain main body 100 is asymmetrical about a longitudinal axis of the drain. In such embodiments, one side is installed against a vertical wall of the basin. Tile from the vertical wall generally extends over a side wall of the drain main body 100, and floor tile is installed over the top surface of the other side up to the main drain channel opening. In a further embodiment, an upper portion of one side wall of the drain main body 100 comprises a stairstep-like shelf extending longitudinally along the length of the drain. In an embodiment, the shelf is configured to receive and support gypsum board, also known as drywall, or another type of wall board.

In an embodiment, a tile floor can be installed abutting the drain system 1 of the present invention. In further embodiments, a tile floor can be installed overlaying all or a portion of a top surface 164 of one or both drain main body side walls 160. In an exemplary embodiment, the tile floor is installed with at least a slight slant toward the drain, such as over a slanted waterproofing foam layer 900, an embodiment of which is shown in FIG. 32. In an exemplary embodiment, the top surface 164 of each side wall 160 is slanted toward the drain channel opening 122 to aid in directing liquid toward the wastewater drain. Once installed, the present drain system 1 is configured to direct liquid from the tile basin in which it is installed to a corresponding wastewater drain line.

In some embodiments, the drain system 1 comes in a kit that includes all items necessary for an installer to install the drain. Specifically, in some embodiments of the present invention, a kit includes a drain coupler piece 120, one or more drain extension piece(s) 140, two end caps 200, a glue or adhesive for connecting drain pieces, a roll of fiber mesh tape, a tube of adhesive, drain shims 600, cement board shims, compatible waterproofing caulk, a light box assembly 300, associated waterproof light(s) 400, or some combination thereof. In an embodiment, during installation, an installer cuts the drain extension piece(s) 140 to the desired length and glues together the drain pieces to form an assembled drain.

In an exemplary embodiment, the body of the floor drain system 1 is made up of polyvinyl chloride (PVC). In alternative embodiments, the body of the floor drain system 1 is made up of any other rigid, watertight material. In some embodiments the body of the drain system 1 is manufactured through a blow molding process. In an exemplary embodiment of the present invention, the floor drain system 1 is easy to adjust to a desired size and to install into in a tile basin.

Embodiments of the instant invention provide a tile floor drain that is completely or generally “watertight” (e.g., allows for the waterproofing layer at the top of the concrete to continue all the way to the edge of the drain body). In embodiments of the present invention, the drain is adjustable in height and configured for relatively easy installation in basins of varying dimensions.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° C., or 4.25° C.-5.75° C. When referring to nominal temperature, such as “about −50° C. to about ±50° C.,” the term “about” means ±5° C. Thus, for example, the phrase “about 37° C.” means 32° C.-42° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

1. A drain system comprising:
a coupler piece comprising a drain connector defining a drain opening for connection to a drain line;
said coupler piece further comprising opposed first and second receivers, said first receiver configured for engagement with a first drain extension piece and said second receiver configured for engagement with a second drain extension piece;
wherein said coupler piece, said first drain extension piece, and said second drain extension piece together form a main body having first and second ends;
said main body defining a channel between first and second side walls extending along a longitudinal length of said main body;
first and second end pieces configured to seal said first and second ends of said main body, respectively; and
wherein said drain system is configured to receive a liquid and direct the liquid along said channel to the drain line.

2. The drain system of claim 1, wherein:
each of said first and second side walls comprises a lip extending along the longitudinal length of said main body and a distance inward and configured for mounting a drain cover.

3. The drain system of claim 2, further comprising:
one or more shims, each shim configured for placement between one of said lips and said drain cover for vertical adjustment of said drain cover relative to said main body.

4. The drain system of claim 2, further comprising:
one or more magnets positioned along the longitudinal length of said main body and configured for magnetic interaction with said drain cover.

5. The drain system of claim 1, wherein:
said main body is configured to be embedded within a tile floor such that tiles of a tile layer extend over and overlay at least a portion of a top surface of each of said first and second side walls.

6. The drain system of claim 1, wherein:
each of said first and second drain extension pieces are configured for being cut down to a desired length.

7. The drain system of claim of claim 1, wherein:
said first and second receivers are shaped to closely fit around lower brims of said first and second drain extension pieces, respectively.

8. The drain system of claim 1, wherein:
said main body is made up of polyvinyl chloride (PVC).

9. The drain system of claim 1, wherein:
said first and second drain extension pieces are connected to said coupler piece via a bonding agent.

10. The system of claim 1, wherein:
said first and second end pieces are connected to said first and second ends of said main body via a bonding agent.

11. The system of claim 1, wherein:
said first end piece comprises a light box end piece comprising a housing defining a bottom opening into said channel and an upper opening configured for providing access behind a wall adjacent to said drain system.

12. The system of claim 11, wherein:
said light box end piece housing is configured to house components of lighting positioned within said channel and to accommodate power connection of said lighting behind the wall adjacent to said drain system.

13. The system of claim 11, wherein:
a proximal side of said light box end piece housing is configured for being positioned in line with drywall of the wall adjacent to said drain system.

14. The system of claim 11, wherein:
said light box end piece further comprises an access door providing access into said housing near said first end of said main body.

15. A method of installing a drain comprising:
providing a drain comprising a coupler piece including a drain connector defining a drain opening and opposed first and second receivers configured for engagement with first and second drain extension pieces, respectively;
connecting said first drain extension piece to said first receiver and said second drain extension piece to said second receiver so as to form a drain main body having first and second ends;
wherein said main body defines a channel between first and second side walls extending along a longitudinal length of said main body;
sealing first and second end of said main body with first and second end pieces, respectively;
placing said main body within a tile basin such that said drain connector connects to a drain line and such that said drain is configured to receive a liquid from said tile basin and direct the liquid along said channel to the drain line.

16. The method of claim 15, further comprising:
cutting said first and second drain extension pieces into desired lengths.

17. The method of claim 15, further comprising:
embedding said main body within a tile floor such that tiles of a tile layer extend over and overlay at least a portion of a top surface of each of said first and second side walls.

18. The method of claim 15, wherein each of said first and second side walls comprises a lip extending along the longitudinal length of said main body and a distance inward, the method further comprising:
mounting a drain cover on said lips.

19. The method of claim 18, further comprising:
placing one or more shim between each lip and said drain cover to vertically adjust the height of said drain cover relative to said main body.

20. The method of claim 15, wherein said first end piece comprises a light box end piece comprising a housing defining a bottom opening into said channel and an upper opening configured for providing access behind a wall adjacent to said drain system, the method further comprising:
placing a light strip into said channel through said light box end piece housing bottom and upper openings.
